(19) United States
(12) Patent Application Publication
(10) Pub. No.: US 2021/0299667 A1
(43) Pub. Date: Sep. 30, 2021

(54) PHOTONIC THERMOCYCLING DEVICES AND METHODS

(71) Applicant: Ontera Inc., Santa Cruz, CA (US)

(72) Inventors: Weidong Cao, North Potomac, MD (US); Trevor Sierra Foss, Pacific Grove, CA (US); Brandy Michelle Baird, Santa Cruz, CA (US); Jeffrey William Reed, Santa Cruz, CA (US); Mark Frederick Senko, Santa Cruz, CA (US); Andrea W. Chow, Los Altos, CA (US)

(21) Appl. No.: 17/211,750

(22) Filed: Mar. 24, 2021

Related U.S. Application Data
(60) Provisional application No. 63/000,143, filed on Mar. 26, 2020.

(51) Int. Cl. B01L 7/00

(52) U.S. Cl. CPC B01L 7/52; B01L 2300/1861; B01L 2300/1805

(57) ABSTRACT

A photonic thermocycling device is configured to thermocycle a biological sample. The thermocycling device comprises a light source configured to emit an illumination beam, a reaction block holding a reaction chamber, and a light-absorbing film is coupled to the reaction block and configured to absorb and convert the illumination beam into thermal energy to heat the reaction chamber. A controller generates instructions for operation of the thermocycling device. The thermocycling device may further comprise a temperature sensor to measure the temperature of the reaction chamber for calibration of the instructions. A convection cooling element may also be implemented to provide rapid cooling of the reaction chamber. A lens assembly may be implemented for directing and conditioning light generated by the light source towards the light-absorbing film. A second partial light-absorbing film may be included and coupled on an opposite side of the first light-absorbing film, to improve heating uniformity.

### CROSS REFERENCE TO RELATED APPLICATIONS

This application claims benefit of and priority to U.S. Provisional Application No. 63/000,143 filed on Mar. 26, 2020, which is incorporated by reference herein in its entirety.

### BACKGROUND

Polymerase chain reaction (PCR) is a technology that amplifies a specific piece of DNA to a significant level that can be detected by conventional detection methods. The typical PCR is a process that cyclically alters the solution temperature between three phases: a denature phase where the temperature is set around 95° C.; an anneal phase where the temperature is set between 50-60° C., and an extension phase where the temperature is set around 68-72° C. The routine PCR takes 2-3 hours for amplification time, which is not favorable for point of care test (POCT) applications. Many technologies and methods have been developed to speed up the amplification process in order to meet the POCT requirement. However, challenges remain, such as: heating uniformity, heat speed, PCR temperature sensing, cooling efficiency, feasibility of integration into platforms/systems, among other challenges.

Heating is usually achieved by a contact heating method, such as heating block, electrical heat pad or liquid heat exchange, or non-contact heating methods, such as infrared laser heating and tungsten lamp heating. However, contact-based heating methods can introduce undesired design constraints for PCR platforms and systems. Current non-contact-based heating methods can also be improved.

### SUMMARY

Non-contact heating solutions can provide more flexibility for system design and integration. However, non-contact heating solutions require specific radiation wavelengths and/or high-power inputs. For instance, laser infrared heating requires a 1500 nm laser and tungsten lamp heating requires a 50 W power input. In one example of a non-contact heating solution, blue LED light is absorbed by a nano gold layer and converted to thermal energy via plasmonic photothermal effect to heat the PCR solution, which allows for rapid heating and/or cooling, with significantly reduced power output requirements (e.g., from 1 W-20 W, with lower power output requirements).

Embodiments of the thermocycling device and methods described herein can omit nano gold coating (e.g., on or near a bottom surface of a PCR chamber), in the interests of facilitating mass production, providing a less inhibitory environment for PCR reactions (e.g., with suitable biocompatible materials), and sensing temperatures of solutions involved in PCR reactions with small volumes (e.g., microliter volumes, nanoliter volumes).

Embodiments described cover a general photonic thermocycling device and methods that are based on a light-absorbing film that converts a broad range of radiation wavelengths (e.g., from UV wavelengths to infrared wavelengths, non-specific radiation wavelength) into thermal energy as the heat resource for the thermocycling device. In variations, the thermocycling device can further include a temperature sensor configured to measure a temperature of the reaction chamber and provide real-time feedback during thermocycling for real-time calibration. In variations, the thermocycling device can further incorporate a convection cooling element for active cooling of the reaction chamber. In variations, the thermocycling device can also incorporate a lens assembly and/or other optics comprising one or more optical elements and configured to condition and direct the illumination beam to be incident upon the light-absorbing film. In variations, the thermocycling device can also comprise a second partial light-absorbing film that is disposed on an opposite side of the reaction block to the first light-absorbing film.

In one or more embodiments, a thermocycling device is disclosed, comprising: a light source configured to emit an illumination beam; a reaction block supporting a reaction chamber configured to receive a sample; a first light-absorbing film coupled to the reaction block, the first light-absorbing film positioned along an illumination path for absorption of the illumination beam emitted by the light source and positioned for transmission of thermal energy, derived from an interaction between the illumination beam and the first light-absorbing film, to the reaction chamber; and a controller configured to generate instructions for the light source based on a thermocycling profile.

In one or more embodiments, the light source is a light emitting diode (LED) with power selected from a range of 1 Watt to 20 Watts.

In one or more embodiments, the thermocycling device further comprises: a lens assembly configured to direct the illumination beam emitted by the light source toward the first light-absorbing film with a directed and collimated beam profile.

In one or more embodiments, the reaction chamber is substantially planar and has a volume selected from a range of 10 nL to 200 μL.

In one or more embodiments, the light-absorbing film is composed of a pyrolytic graphite material.

In one or more embodiments, the light source is positioned on a first side of the reaction block, and wherein the first light-absorbing film is coupled to the first side of the reaction block.

In one or more embodiments, the light source is positioned on a first side of the reaction block, and wherein the first light-absorbing film is coupled to a second side of the reaction block that is opposite the first side.

In one or more embodiments, the thermocycling device further comprises: a second light-absorbing film coupled to a second side of the reaction block, wherein the light source is positioned on a first side of the reaction block that is opposite the second side of the reaction block, wherein the first light-absorbing film is coupled to the first side of the reaction block and is configured to partially transmit the illumination beam emitted by the light source.

In one or more embodiments, the first light-absorbing film includes a pattern comprising a plurality of portions that are transmissive with remaining portions of the pattern composed of a light-absorbing material.

In one or more embodiments, the thermocycling device further comprises: a convection cooling element coupled to the reaction block and configured to flow a fluid in contact with the reaction block to cool the reaction chamber based on the instructions.

In one or more embodiments, the thermocycling device further comprises: a temperature sensor configured to measure a temperature of the reaction chamber, and wherein the controller is further configured to calibrate the instructions based on a comparison of the temperature measured by the temperature sensor and the thermocycling profile.

In one or more embodiments, the light source is positioned on a first side of the reaction block and the temperature sensor is positioned on a second side of the reaction block that is opposite the first side.

In one or more embodiments, the temperature sensor and the light source are positioned on one side of the reaction block.

In one or more embodiments, the temperature sensor is an infrared sensor.

In one or more embodiments, a thermocycling device is disclosed, comprising: a reaction block; a first thermocycling unit comprising: a first light source configured to emit a first illumination beam, a first reaction chamber embedded in the reaction block and configured to receive a first sample, and a first light-absorbing film coupled to the reaction block, the first light-absorbing film positioned along an illumination path for absorption of the first illumination beam emitted by the first light source and positioned for transmission of thermal energy, derived from an interaction between the first illumination beam and the first light-absorbing film, to heat the first reaction chamber; a second thermocycling unit comprising: a second light source configured to emit a second illumination beam, a second reaction chamber embedded in the reaction block and configured to receive a second sample, and a second light-absorbing film coupled to the reaction block, the second light-absorbing film positioned along an illumination path for absorption of the second illumination beam emitted by the second light source and positioned for transmission of thermal energy, derived from an interaction between the second illumination beam and the second light-absorbing film, to heat the section reaction chamber; and a controller configured to generate instructions for the first and the second light sources.

In one or more embodiments, the instructions cause the first thermocycling unit to thermocycle according to a first thermocycling profile and the instructions cause the second thermocycling unit to thermocycle according to a second thermocycling profile that is different from the first thermocycling profile.

In one or more embodiments, a method is disclosed, comprising: obtaining a test sample and a thermocycling profile for thermocycling the test sample; generating instructions for a thermocycling unit based on the thermocycling profile; and thermocycling the test sample with the thermocycling unit based on the instructions, by: emitting, via a light source of the thermocycling unit, an illumination beam based on the instructions, and wherein the illumination beam is incident upon a light-absorbing film coupled to a reaction block of the thermocycling unit comprising a reaction chamber that holds the test sample, wherein the light-absorbing film converts the illumination beam into thermal energy to heat the reaction chamber.

In one or more embodiments, thermocycling the test sample with the thermocycling unit based on the instructions further comprises: flowing, via a convection cooling element, a fluid in contact with the reaction block to cool the reaction chamber based on the instructions.

In one or more embodiments, the method further comprises: measuring, via a temperature sensor, a temperature of the reaction chamber during the thermocycling of the test sample; calibrating the instructions based on a comparison of the measured temperature to the thermocycling profile; and thermocycling the test sample based on the calibrated instructions.

In one or more embodiments, the thermocycling aids a polymerase chain reaction, the method further comprising: detecting one or more target nucleic acid sequences based on the thermocycled test sample.

### BRIEF DESCRIPTION OF THE DRAWINGS

FIG. 1 illustrates a system environment of a thermocycling device, in accordance with one or more embodiments.

FIG. 2A illustrates a thermocycling unit according to a first arrangement, in accordance with one or more embodiments.

FIG. 2B illustrates a thermocycling unit according to a second arrangement, in accordance with one or more embodiments.

FIG. 2C illustrates a thermocycling unit according to a third arrangement, in accordance with one or more embodiments.

FIG. 2D illustrates a thermocycling unit according to a fourth arrangement, in accordance with one or more embodiments.

FIG. 3 illustrates a thermocycling unit including a lens assembly, in accordance with one or more embodiments.

FIG. 4 illustrates a thermocycling unit including a cooling element, in accordance with one or more embodiments.

FIG. 5A illustrates a thermocycling unit including multiple light-absorbing films, in accordance with one or more embodiments.

FIG. 5B illustrates various patterns of light absorbing films, in accordance with one or more embodiments.

FIG. 6 illustrates a thermocycling device with multiple thermocycling units, in accordance with one or more embodiments.

FIG. 7A illustrates a method flowchart of using a thermocycling device, in accordance with one or more embodiments.

FIG. 7B illustrates a flowchart describing real-time calibration step 750 in method 700, in accordance with one or more embodiments.

FIG. 8 illustrates a method flowchart of using a thermocycling device for Point of Care Testing (POCT), in accordance with one or more embodiments.

FIG. 9 illustrates a temperature sensor readout of a thermocycling unit, according to an example implementation.

FIG. 10 illustrates a gel electrophoresis showing detection results of two targets by a thermocycling unit, according to an example implementation.

FIG. 11 illustrates a gel electrophoresis showing detection results of concurrently run thermocycling units in a thermocycling device, according to an example implementation.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

### System Environment

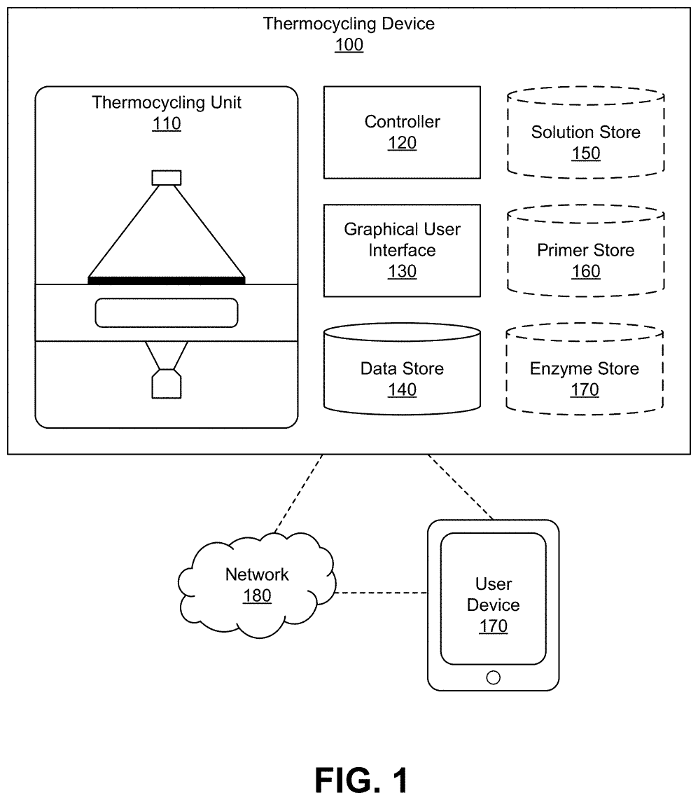

FIG. 1 illustrates a system environment of a thermocycling device 100, in accordance with one or more embodiments. The thermocycling device 100 is configured to thermocycle a biological sample according to a thermocycling profile. In one or more embodiments, the thermocycling device 100 may be used for nucleic acid amplification and quantification for diagnostic applications in contexts such as, but not limited to, clinical laboratories, personalized medicine, agricultural science, veterinary science, forensic science, and environmental science. Example thermocycling techniques that may be accomplished with the thermocycling device 100 include, but are not limited to, 2 step polymerase chain reaction (PRC), 3 step PCR, reverse transcription PCR (RT-PCR), touch down PCR (TD-PCR), isothermal amplification, thermal lysis, etc. Touch down PCR is a modified PCR algorithm in which the initial annealing temperature is higher than the optimal temperature (Tm) of the primers and is gradually reduced over subsequent cycles until the optimal temperature (Tm) is reached. TD-PCR is particularly useful for templates that are difficult to amplify but can also be standardly used to enhance specificity and product formation.

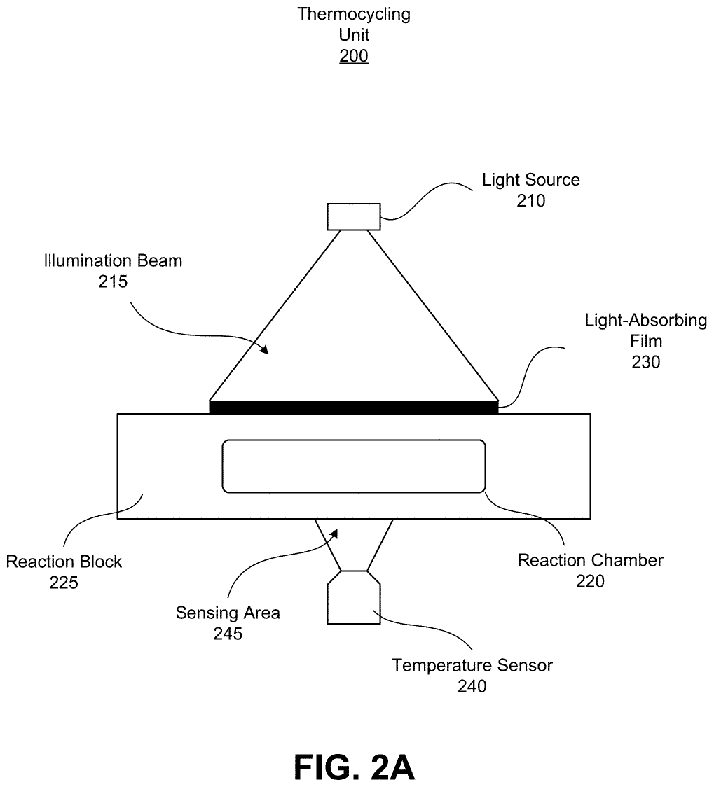

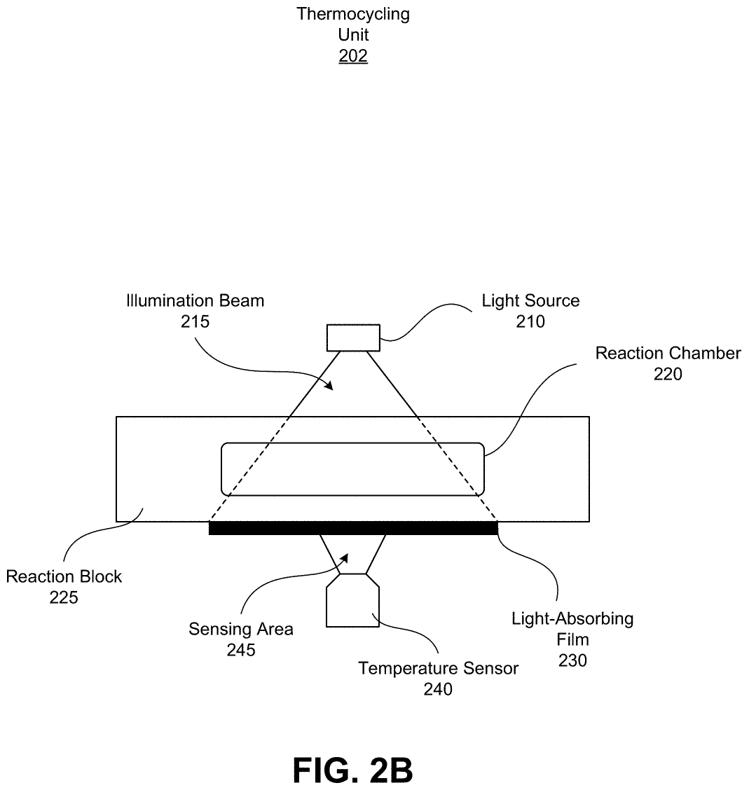

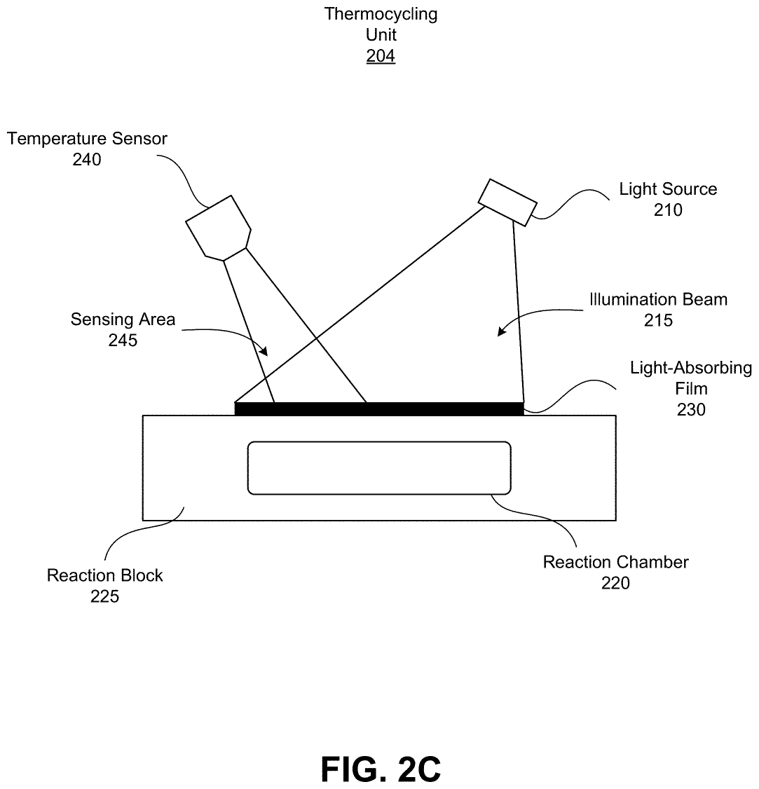

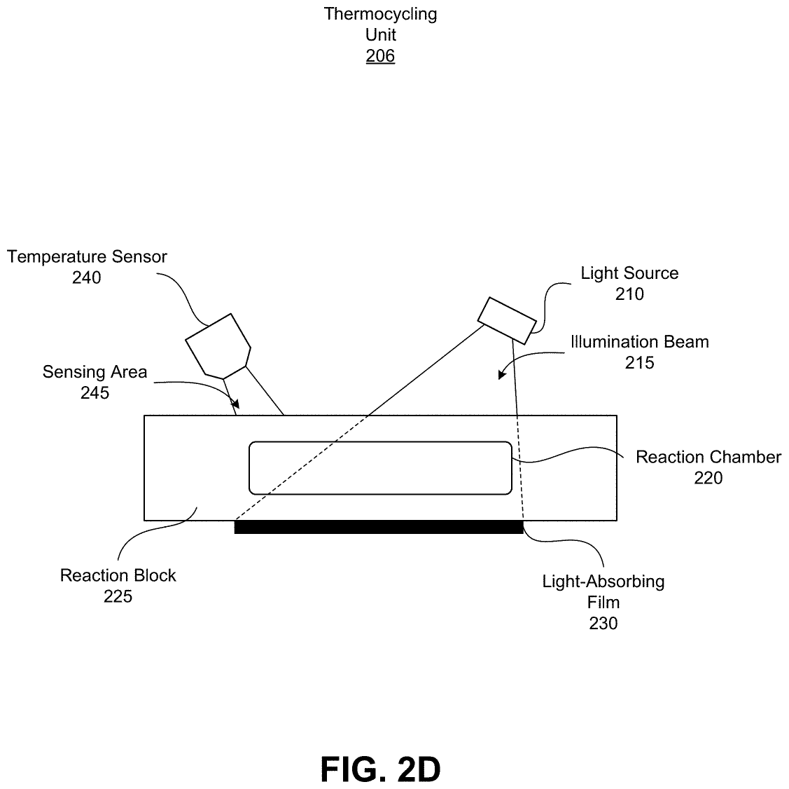

The thermocycling device 100 comprises a thermocycling unit 110, a controller 120, and a graphical user interface (GUI) 130, and a data store 140. The thermocycling unit 110 receives a biological sample and is configured to thermocycle the biological sample according to instructions generated by the controller 120. Dimensions of the thermocycling unit 110 are on the order of hundreds of micrometers to a few centimeters, providing the ability to design a compact thermocycling device 100. The thermocycling unit 110 comprises at least a light source, a reaction chamber where the biological sample is placed, and a light-absorbing film that converts light from the light source into thermal energy. The thermocycling unit 110 may further comprise a lens assembly for directing light generated by the light source, a cooling element for cooling of the reaction chamber, a temperature sensor for recording temperature measurements, an additional light-absorbing film, or any combination thereof. Embodiments of the thermocycling device 100 are described further in FIGS. 2A, 2B, 2C, 3, 4, 5A and 5B.

The controller 120 may be a general computing device comprising one or more computer processors and one or more computer-readable storage media storing instructions for executing software methods. The controller 120 generates the instructions for the thermocycling unit 110 based on a thermocycling profile selected by a user of the thermocycling device via the GUI 130. The controller 120 may also calibrate the instructions based on temperature measurements sensed by a temperature sensor of the thermocycling unit 110. Thermocycling profiles provided by the user may be stored in the data store 140 for subsequent selection.

In some embodiments, the thermocycling device 100 further comprises additional components for automation of certain diagnostic methods. For example, a solution store 150, a primer store 160, and an enzyme store 170 may be incorporated. The solution store 150 stores various solutions that may be added to the biological sample for various thermocycling algorithms. The primer store 160 stores various primers that target specific nucleic acid sequences that are being screened for by the thermocycling device 100. The enzyme store 170 stores various enzymes used by the thermocycling device, e.g., DNA polymerase, RNA polymerase, lyase, etc.

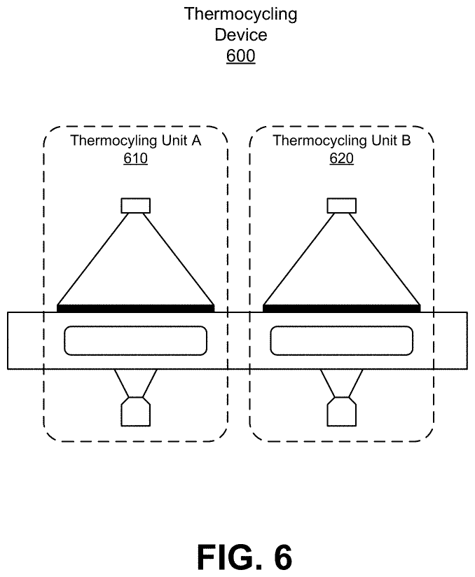

FIG. 6 illustrates a thermocycling device 600 with two thermocycling units, in accordance with one or more embodiments. The thermocycling device 600 is an embodiment of the thermocycling device 100 with multiple thermocycling units. As shown in FIG. 6, the thermocycling device 600 comprises thermocycling unit A 610 and thermocycling unit B 620, which are embodiments of the thermocycling unit 110. The controller 120 of the thermocycling device 600 provides instructions to each of thermocycling units A 610 and B 620 for multiplex operation of both units, i.e., operating both units concurrently. When in multiplex operation, the instructions may instruct thermocycling unit A 610 to thermocycle according to a first thermocycling profile and may instruct thermocycling unit B 620 to thermocycle according to a second thermocycling profile. In various applications of use, multiplexing can be used for thermal lysis followed by a PCR protocol according to various workflows described. Additionally or alternatively, multiple thermocycling units can be used to perform multiple PCR reactions for target multiplexing (e.g., for a panel of targets). Although FIG. 6 depicts two thermocycling units, other embodiments may include any number of thermocycling units. For example, a thermocycling device may comprise 2, 3, 4, 5, 6, 7, 8, 9, 10, 15, 20, 25, 30, 35, 40, 45, 50, 55, 60, 65, 70, 75, 80, 85, 90, 95, 100, 110, 120, 130, 140, 150, 160, 170, 180, 190, or 200 thermocycling units.

Referring back to FIG. 1, the thermocycling device 100 may communicate wirelessly with a user device 170 or via a network 180. The user device 170 may be a general computing device comprising one or more computer processors and one or more computer-readable storage media storing instructions for executing software methods. The user device 170 may serve as an interface for a user for selecting a thermocycling profile for the thermocycling unit 110 (or multiple thermocycling units). The user device 170 may connect directly or indirectly via a network 160 to the thermocycling device 100. Example technologies used for communication include BlueTooth, near field communication (NFC), Wi-Fi, cellular network, low-power wide-area networks, etc. The thermocycling device 100 may also obtain thermocycling profiles from third-party systems, e.g., via the network 180.

### Thermocycling Unit

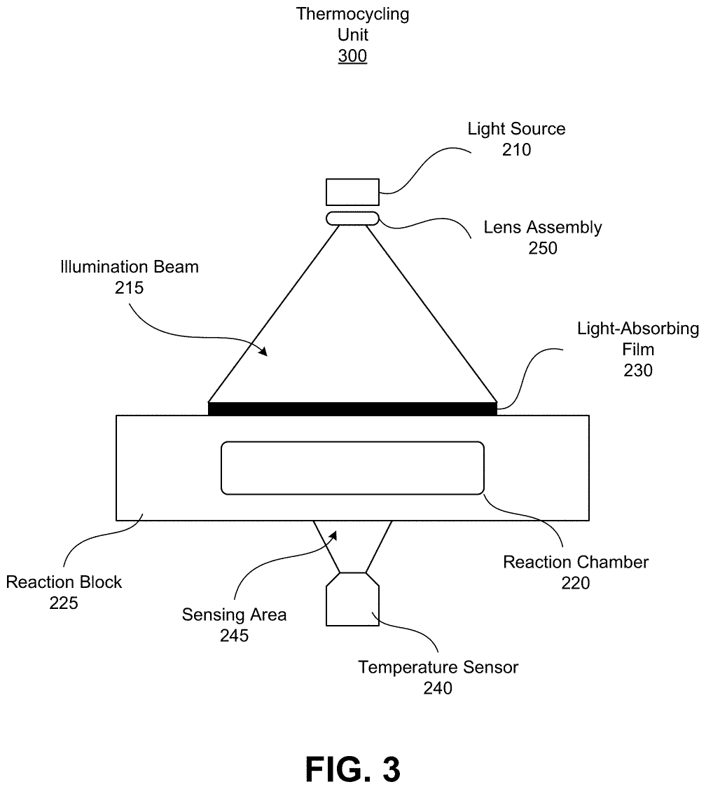

FIGS. 2A, 2B, and 2C illustrate various arrangements of components in a thermocycling unit, in accordance with one or more embodiments. FIGS. 3, 4, 5A, and 5B illustrate additional components that may be implemented in the thermocycling unit, in accordance with one or more embodiments. It may be understood by a skilled artisan in the field that additional or fewer components (e.g., as shown in FIGS. 3, 4, 5A, and 5B) may be incorporated according to one of the arrangements shown in FIGS. 2A, 2B, and 2C. All thermocycling units shown in FIGS. 2A, 2B, 2C, 3, 4, 5A, and 5B and described herein are embodiments of the thermocycling unit 110.

FIG. 2A illustrates a thermocycling unit 200 according to a first arrangement, in accordance with one or more embodiments. The thermocycling unit 200 comprises at least a light source 210, a reaction chamber 220 in a reaction block 225, and a light-absorbing film 230. The thermocycling unit 200 may also comprise a temperature sensor 240. In the first arrangement shown in FIG. 2A, the light-absorbing film 230 is coupled to the reaction block 225 on a first side of the reaction block 225. The light source 210 is also positioned on the first side of the reaction block 225. The temperature sensor 240 is positioned on a second side of the reaction block 225, that is opposite the first side.

The light source 210 emits an illumination beam 215 directed at the light-absorbing film 230 based on instructions generated by the controller 120. The light source 210 may be a light-emitting diode (LED), a liquid crystal diode (LCD), an organic LED (OLED), an inorganic LED (ILED), a superluminescent diode (SLD), a laser diode, a vertical cavity surface emitting laser (VCSEL), another type of light source, etc. In some embodiments, high-power LEDs or high-output LEDs driven at a current selected from the range of hundreds of mA to more than an ampere are implemented. The light source 210 has dimensions ranging from 1.6×1.6 mm to 10×10 mm. The light source 210 has a power selected from a range of 1-30 Watts. The emission spectrum of the light source 210 can be broad (white light) in the visible range or narrow with a wavelength selected from the range of blue to infrared (400-1000 nm). The emission angle of the illumination beam 115 can also range from 90-180 degrees. The illumination beam 115 may have a symmetrical profile that substantially covers the light-absorbing film 230. The profile of the illumination beam 115 can be circular or oval in shape. In some embodiments, additional light sources may be implemented in conjunction with the light source 210. The additional light sources may be positioned adjacent to the light source 210 or in a different position, e.g., positioned on an opposite side of the reaction block 225. The additional light sources may have different characteristics from the light source 210, e.g., may be a different power and/or emit a different wavelength of electromagnetic radiation.

The reaction chamber 220 is configured to receive a biological sample for thermocycling by the thermocycling unit 200. The reaction chamber 220 is an enclosed void embedded in the reaction block 225 that is configured to receive the biological sample, i.e., the reaction block 225 supports the reaction chamber 220. As shown in FIG. 2A, the reaction chamber 220 is substantially flat, i.e., its cross-sectional depth measured along the axis from the top side of the reaction block 225 to the bottom side of the reaction block is substantially less than its length or width (both in the plane when viewed from the light source 210 down towards the reaction block 225). As an example, the reaction chamber 220 has a depth of 100-500 μm with a length and a width, each selected from a range of 1-20 mm (volume on the order of μL). In a smaller scale example, the depth may be selected from a range of 5-100 μm with the length and the wide selected from a range of 500-1000 μm (volume on the order of nL). A substantially small depth provides for quick uniform heating and/or cooling of the biological sample throughout the reaction chamber 220. The reaction chamber has a volume selected from a range of one nanoliter to one milliliter. The reaction chamber 220 may be coupled to one or more microfluidic channels for insertion and removal of fluid from the reaction chamber 220 (e.g., the biological sample, one or more primers, other solutions, etc.). These microfluidic channels may automate certain steps, such as, addition of a solution to the biological sample, transference of the biological sample to a subsequent position in the thermocycling device 100, etc.

The reaction block 225 may be composed of an inelastic material with a high thermal diffusivity. The reaction block 225 transfers thermal energy to and from the reaction chamber 220 (e.g., from the light-absorbing film, or dissipation of thermal energy away from the reaction chamber 220). To improve thermal energy transfer, the reaction chamber 220 may have thin walls on the top and the bottom, i.e., a thin amount of reaction block 225 above and below the reaction chamber 220. The walls of the reaction chamber 220 may be on the order of micrometers, e.g., selected from a range of 4-500 μm. The thermal penetration time (t) for a material of thickness L and thermal diffusivity (α) is: t=L²/4α. Therefore, a shorter thermal penetration time (and consequently sharper thermocycling) is achieved with a thinner thickness including the depth of the reaction chamber 220 and wall thicknesses of the reaction block 225.

The light-absorbing film 230 converts light energy into thermal energy. The light-absorbing film 230 has high optical absorbance in the visible spectrum, including the emission wavelength of the illumination beam 215. The light-absorbing film 230 also has a high thermal conductivity, e.g., in the range of 10-1000 W/mK (Watts per meter-Kelvin). The light-absorbing film 230 may have a thickness selected from the range of 10-100 μm. In some embodiments, the light-absorbing film is composed of a pyrolytic graphite film with a thermal conductivity of 900 W/mK in the planar direction and a 15 W/mK in the depth direction. Other materials that may be used to construct the light-absorbing film 230 include, but are not limited to, black printable compounds with high thermal conductivity, carbon black, metal, ceramic, diamond particles, or some combination thereof. Heating speed of the reaction chamber 220, via the light-absorbing film 230, can reach up to 20° C./s or faster. The light-absorbing film 230 may also operate as a heat dissipator given its high thermal conductivity.

The temperature sensor 240 measures the temperature of the reaction chamber 220 (or parts of the reaction block 225 serving as walls to the reaction chamber 220). In some embodiments, the temperature sensor 240 is a non-contact temperature sensor. In other embodiments, the temperature sensor 240 is a contact temperature sensor. In some embodiments, the temperature sensor 240 is an infrared sensor capable of detecting infrared radiation and calculating a temperature based on the detected infrared radiation. The sensing area 245 is a field of view of the temperature sensor 240, wherein the calculated temperature corresponds to the temperature of the sensing area 245.

FIG. 2B illustrates a thermocycling unit 202 according to a second arrangement, in accordance with one or more embodiments. In this embodiment, the light-absorbing film 230 is coupled to the bottom side of the reaction block 225. The light source 210 is positioned on the top side of the reaction block 225, and the temperature sensor is positioned on the bottom side of the reaction block 240. In this embodiment, the illumination beam 215 transmits through the reaction block 225 and the reaction chamber 220 and is converted by the light-absorbing film 230 on the bottom side of the reaction block 225. In order for the illumination beam 215 to be able to transmit through, the reaction block 225 is composed of a transmissive material of high thermal diffusivity.

FIG. 2C illustrates a thermocycling unit 204 according to a third arrangement, in accordance with one or more embodiments. In this embodiment, the light-absorbing film 230 is coupled to the top side of the reaction block 225 (as in FIG. 2A). The light source 210 is positioned on the top side of the reaction block 225 but offset and angled from the center so that the illumination beam 215 optimally illuminates the light-absorbing film 230. The temperature sensor 240 is also positioned on the top side of the reaction block 225 with the sensing area 245 on the light-absorbing film 230.

FIG. 2D illustrates a thermocycling unit 206 according to a fourth arrangement, in accordance with one or more embodiments. In this embodiment, the light-absorbing film 230 is coupled to the bottom side of the reaction block 225. The light source 210 is positioned on the top side of the reaction block 225 but offset and angled from the center, and the temperature sensor is also positioned on the top side of the reaction block 240 but offset and angled from the center. In this embodiment, the illumination beam 215 transmits through the reaction block 225 and the reaction chamber 220 and is converted by the light-absorbing film 230 on the bottom side of the reaction block 225. In order for the illumination beam 215 to be able to transmit through, the reaction block 225 is composed of a transmissive material of high thermal diffusivity.

FIG. 3 illustrates a thermocycling unit 300 including a lens assembly 250, in accordance with one or more embodiments. In the thermocycling unit 300 shown in FIG. 3, the light source 210, the reaction chamber 220, the reaction block 225, the light-absorbing film 230, and the temperature sensor 240 are arranged relative to FIG. 2A, the first arrangement. The lens assembly 250 is positioned between the light source 210 and the light-absorbing film 230.

The lens assembly 250 is configured to direct light generated by the light source 210 to the light-absorbing film 230 as the illumination beam 215. The lens assembly comprises one or more optical elements for directing and conditioning the illumination beam 215. Some example optical elements include a lens, a reflector, a collimator, a polarizer, a diffraction grating, etc. One example optical element incorporating one or more lenses and one or more reflectors is a total internal reflection (TIR) lens, which can be used to shape the angle of the illumination beam 215. The TIR lens collimates light from a large number of incident angles as emitted from the light source 210 to produce a directional illumination beam 215, wherein all the light travels in one direction. In one embodiment, an LED optic lens is selected to alter the Full Width Half Maximum (FWHM, the angle at which the illumination intensity is 50% of the central maximum value) value of an LED source from greater than 120 degrees to less than 40 degrees. The lens assembly 250 generally has high optical transmission efficiency, e.g., 85-90%.

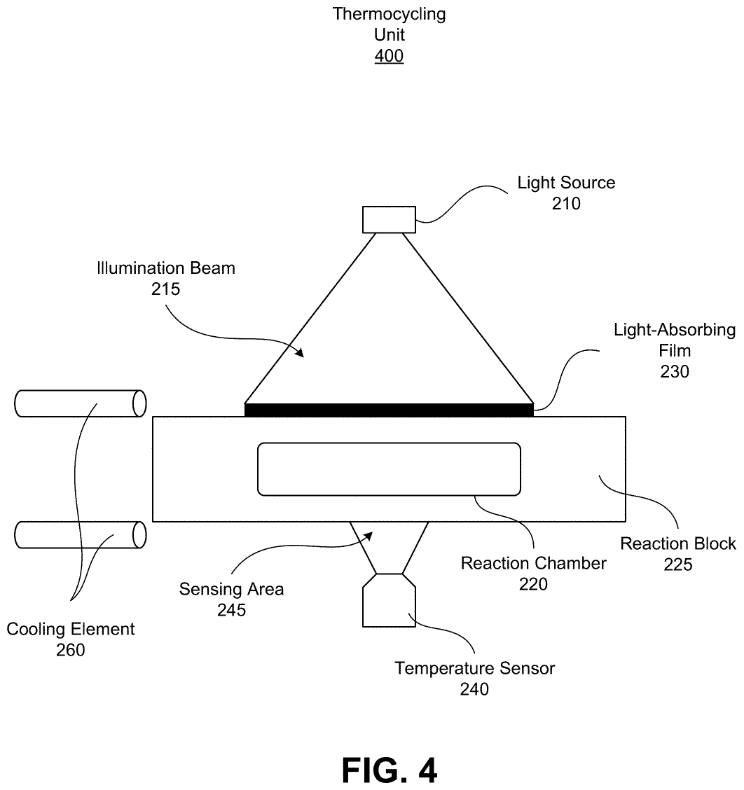

FIG. 4 illustrates a thermocycling unit 400 including a cooling element 260, in accordance with one or more embodiments. In the thermocycling unit 400 shown in FIG. 4, the light source 210, the reaction chamber 220, the reaction block 225, the light-absorbing film 230, and the temperature sensor 240 are arranged relative to FIG. 2A, the first arrangement. The cooling element 260 in FIG. 4 can be a convection cooling element having two channels (or another suitable number of channels or other formats) for directing fluid to be in contact with the reaction block 225.

The cooling element 260 flows fluid in contact with the reaction block 225 to cool the reaction block 225 and the reaction chamber 220, in accordance with the instructions generated by the controller 120. In one embodiment, the two channels of the convection cooling element 260 output air that travels across the top side and the bottom side of the reaction block 225. In other embodiments, there are variable number of channels, e.g., there is 1, 2, 3, or 4 channels implemented to direct fluid for convection cooling. In one example implementation, air is output by the channels of the convection cooling element 260 through a proportional valve. The proportional valve can output up to 10 liters per minute (LPM) of air flow at 20-50 pounds per square inch of pressure (psi) supplied by an air compressor. Using as air as the fluid, the cooling speed of the reaction chamber rise up to 20° C./s.

In another embodiment, the convection cooling element 260 comprises two channels connected to a cooling chamber coupled to one side of the reaction block 225. The first channel inputs a liquid coolant into the cooling chamber. While in the cooling chamber, the liquid coolant absorbs thermal energy from the reaction block 225. Then the second channel outputs the liquid coolant with the transferred thermal energy from the reaction block 225. In other embodiments, the convection cooling element 260 may comprise additional protrusions composed of materials of high thermal conductivity, to aid in dissipation of thermal energy away from the reaction chamber 220.

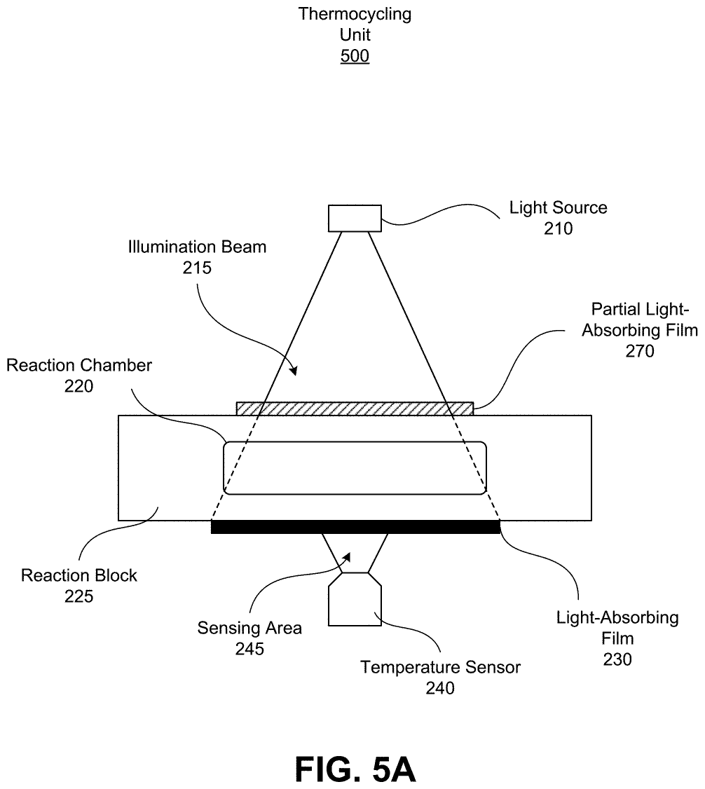

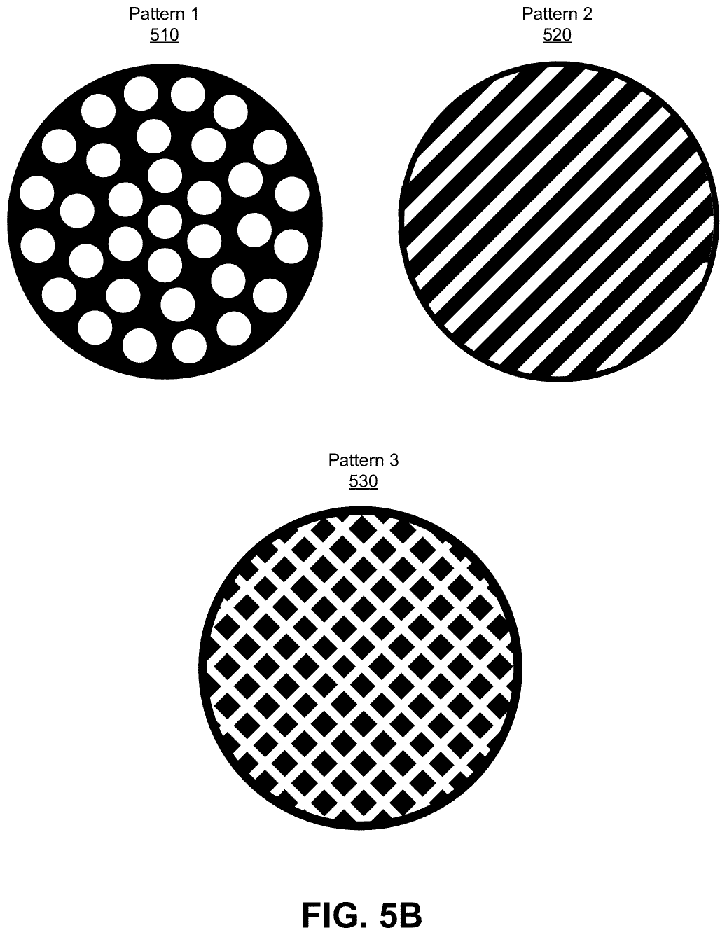

FIG. 5A illustrates a thermocycling unit 500 including two light-absorbing films, in accordance with one or more embodiments. In the thermocycling unit 500 shown in FIG. 5A, the light source 210, the reaction chamber 220, the reaction block 225, the light-absorbing film 230, and the temperature sensor 240 are arranged relative to FIG. 2B, the second arrangement. In addition to those components, the thermocycling unit 500 includes a second partial light-absorbing film 270. The partial light-absorbing film 270 is coupled to the top side of the reaction block 225. One advantage of using the partial light-absorbing film 270 in addition to the light-absorbing film 230 is more uniform heating of the reaction chamber 220 from both the top and the bottom side.

The partial light-absorbing film 270 converts part of the illumination beam 215 into thermal energy while transmitting part of the illumination beam 215. The partial light-absorbing film 270 may be composed of the same light-absorbing materials as the light-absorbing film 230. A patterning of the light-absorbing materials in the partial light-absorbing film 270 would allow for areas with a light-absorbing material to absorb and convert the illumination beam 215 into thermal energy, while the portions omitting any light-absorbing material would provide transmission of the illumination beam 215. The percentage of the illumination beam 215 incident on the partial light-absorbing film 270 that would be converted to thermal energy and the percentage of the illumination beam 215 that would be transmitted could be optimized based on the patterning.

FIG. 5B illustrates example patterning of the partial light-absorbing film 270, in accordance with one or more embodiments. In example pattern 1 510, the black portions correspond to light-absorbing material wherein the white circles correspond to transmissive portions. Sizes of the white circles can be adjusted to be smaller or larger. In example pattern 2 520, the pattern resembles a grating pattern where the black portions correspond to light-absorbing material and the white portions correspond to transmissive portions. The size of the grates can also be adjusted to be smaller or larger. In example pattern 3 530, the pattern resembles a hatch pattern. Generally, smaller features (smaller circles, smaller grates, smaller hatching) may improve heating uniformity with the tradeoff of manufacturing complexity. The aggregate area of the black portions over the total area of the partial light-absorbing film 270 corresponds to the conversion percentage. The aggregate area of the white portions over the total area of the partial light-absorbing film 270 corresponds to the transmission percentage.

### Exemplary Methods

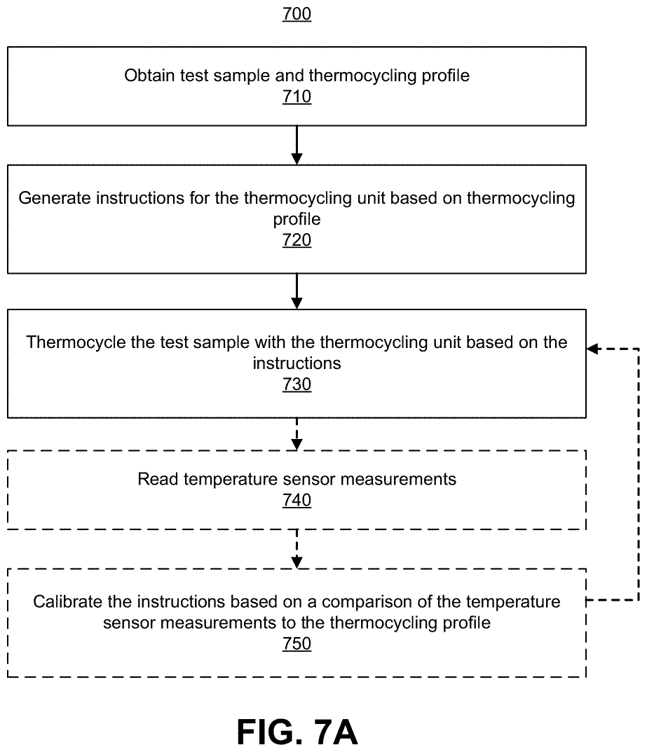

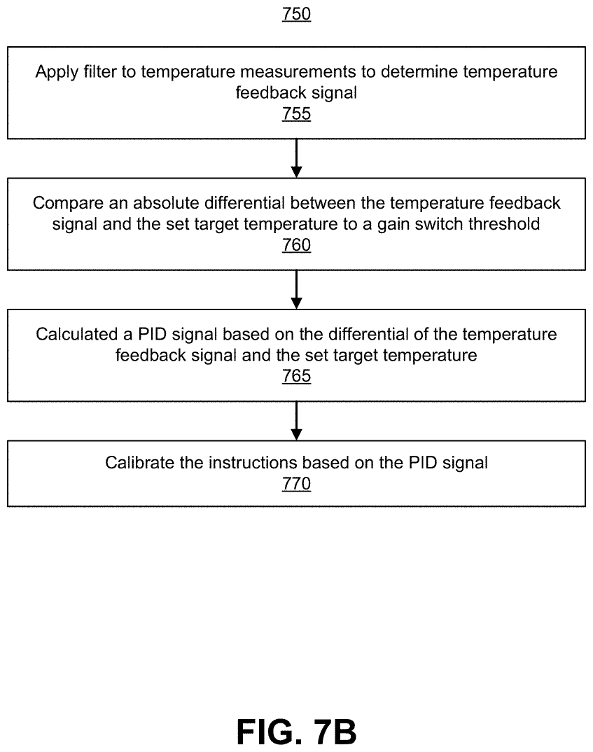

FIG. 7A illustrates a method 700 flowchart of using the thermocycling device 100, in accordance with one or more embodiments. The method 700 may be performed by the thermocycling device 100. One of ordinary skill in the art will appreciate that other components described herein this disclosure may perform one or more steps described in the method 700.

The thermocycling device 100 obtains 710 a test sample and a thermocycling profile for the test sample. The thermocycling device 100 may be configured to receive the test sample from an input location of the thermocycling device 100, where the user may input the biological sample. The thermocycling device 100 directs the biological sample to an appropriate thermocycling unit from the input location. The user may select the thermocycling profile on the GUI 130 of the thermocycling device 100 or may select the thermocycling profile on the user device 170. Generally, a thermocycling profile includes one or more steps, wherein each step has a set temperature and a duration. Generally for PCR algorithms, the thermocycling profile cycles through three phases: a denaturation phase to split DNA molecules, an annealing phase which allows the primers to anneal to one or more target DNA sequences, and an extension phase where the DNA polymerase locates the primers and extends the target DNA sequences, thus amplifying the target DNA sequences.

The thermocycling device 100 generates 720 instructions for the thermocycling unit 110 based on the thermocycling profile. The controller 120 of the thermocycling device 100 generates instructions for the various components of the thermocycling unit 110.

The thermocycling device 100 thermocycles 730 the test sample with the thermocycling unit 110 based on the instructions. For example, the instructions cause the light source of the thermocycling unit 110 to emit an illumination beam having certain characteristics like timing, power, wavelength, duration, etc. The instructions may also cause the convection cooling element to output fluid at certain parameters like timing, amount of fluid, duration, etc. In embodiments with multiple thermocycling units, the instructions may cause a first thermocycling unit to thermocycle according to a first thermocycle profile while causing a second thermocycling unit to thermocycle according to a second thermocycle profile. Upon finishing a thermocycling algorithm such as PCR, the thermocycled test sample may be screened for target nucleic acid sequences, e.g., via a gel electrophoresis.

In some embodiments, the thermocycling device 100 incorporates a feedback loop. The thermocycling device 100 reads 740 the temperature sensor measurements captured by the temperature of the thermocycling unit 110.

The controller 120 of the thermocycling device 100 calibrates the instructions based on a comparison of the temperature sensor measurements to the thermocycle profile. If there is a difference beyond a threshold tolerance, the controller 120 may adjust the instructions to minimize the difference. For example, if the temperature sensor is reading that the reaction chamber is 10 degrees Celsius below the set denaturation temperature for a denaturation step, the controller 120 may adjust the instructions to increase power output by the light source of the thermocycling unit. In another example, if the temperature sensor is reading that the reaction chamber is 10 degrees Celsius above the set annealing temperature for an annealing step, the controller 120 may adjust the instructions to increase cooling speed of the cooling element. The thermocycling device 100 continues with thermocycling with the calibrated instructions at step 730. The thermocycling device 100 may constantly calibrate the instructions throughout the duration of the thermocycling profile. Providing real-time feedback via the temperatures sensors allows for ensuring accurate and precise heating and cooling of the reaction chamber throughout a thermocycling algorithm.

FIG. 7B illustrates a flowchart describing real-time control step 750 in method 700, in accordance with one or more embodiments. FIG. 7B illustrates embodiments where a proportional-integral-derivative (PID) algorithm is incorporated in the feedback control instructions. The steps shown in FIG. 7B may be performed by the thermocycling device 100. One of ordinary skill in the art will appreciate that other components described herein this disclosure may perform one or more steps in FIG. 7B.

The thermocycling device 100 applies 755 a filter to temperature measurements detected by the temperature sensor to determine a temperature feedback signal. The filters may aid in conditioning the data for use in real-time calibration. Example filters can denoise the temperature measurements, account for delay between heating and/or cooling by the thermocycling device and temperature measurements by the temperature sensor, take a moving average (for denoising), among other operations.

The thermocycling device 100 compares 760 a differential between the temperature feedback signal and the set target temperature to a gain switch threshold. If the differential is above the gain switch threshold, a first PID algorithm may be applied to calibrate the instructions. If the differential is below the gain switch threshold, a second PIC algorithm may be applied.

In one embodiment, the first PID algorithm may correspond to calibration of the instructions relating to heating of the reaction chamber, i.e., instructions to control the duty cycle of the power to the light source of the thermocycling unit, while the second PID algorithm corresponds to calibration of the instructions relating to cooling of the reaction chamber, i.e., instructions to control the duty cycle of the proportional valve of the cooling element.

In another embodiment, the absolute differential is compared to the gain switch threshold. If the absolute differential is above the gain switch threshold, then the first PID algorithm is applied to the instructions for both heating and cooling, whereas if the absolute differential is below the gain switch threshold, no adjustments are made. This embodiment can disregard slight noise and/or variance in the temperature feedback signal, i.e., if the absolute differential between the temperature feedback signal and the target temperature is within 1° C., then forego any adjustments.

The thermocycling device 100 calculates 765 a PID signal based on the differential of the temperature feedback signal and the set target temperature. The PID signal comprises three components: a proportional component to account for the size of the difference, an integral component to account for residual error in past calibrations, and a derivative component to predict a future trend in the differential. The strength of each component may be tuned to smooth out calibration, e.g., to avoid compounding overcorrections.

The thermocycling device 100 calibrates 770 the instructions based on the PID signal. According to the embodiment with two PID algorithms (one for heating calibration and one for cooling calibration), the PID signal is directed to either heating calibration or cooling calibration, based on which PID algorithm was used. The thermocycling device 100 may calibrate the instructions to adjust heating or cooling as directed by the PID signal. Using separate PID algorithms to calibrate heating versus cooling provides greater control in each calibration. In the embodiment utilizing one PID algorithm, the thermocycling device 100 calibrates the instructions to adjust heating and/or cooling based on the PID signal.

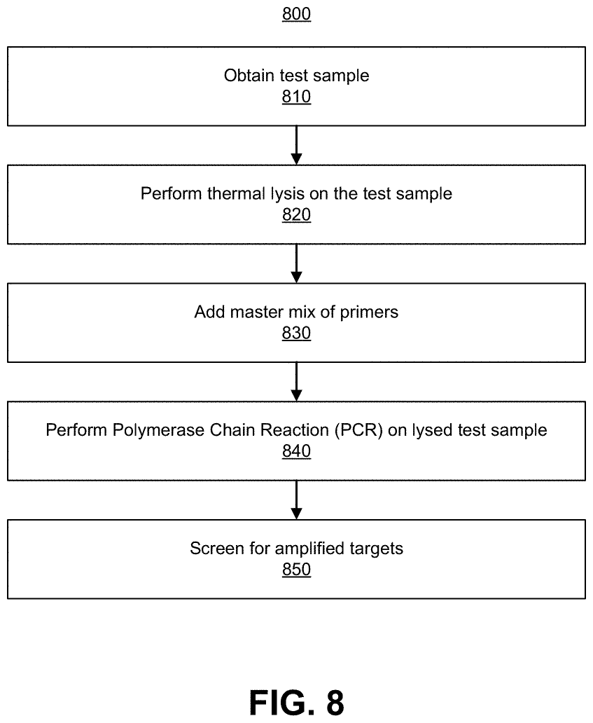

FIG. 8 illustrates a method 800 flowchart of using the thermocycling device 100 for Point of Care Testing (POCT), in accordance with one or more embodiments. The method 800 may be performed by the thermocycling device 100. One of ordinary skill in the art will appreciate that other components described herein this disclosure may perform one or more steps described in the method 700.

The thermocycling device 100 obtains 810 a test sample. The thermocycling device 100 may be configured to receive the test sample from an input location of the thermocycling device 100, where the user may input the biological sample. The thermocycling device 100 directs the biological sample to an appropriate thermocycling unit from the input location.

The thermocycling device 100 performs 820 thermal lysis on the test sample. The thermocycling device 100 may generate instructions for the thermal lysis algorithm. The instructions may cause the thermocycling device 100 to add solution and/or a lyase enzyme to the test sample, e.g., via microfluidic channels connected to the reaction chamber of the respective thermocycling unit. The instructions may also cause the light source of the thermocycling unit to emit an illumination beam to heat up the reaction chamber to lyse the test sample.

The thermocycling device 100 adds 830 a master mix of primers for target nucleic acid sequences. The thermocycling device may also add a polymerase enzyme and, optionally, additional solution to the reaction chamber. The primers are designed to target specific nucleic acid fragments. The master mix of primers, the polymerase enzyme, and any additional solution may be added via microfluidic channels connected to the reaction chamber of the respective thermocycling unit. In some embodiments, one thermocycling unit is designated for thermal lysis with a second thermocycling unit designated for PCR. The lysed sample may be transferred from the first unit to the second unit.

The thermocycling device 100 performs 840 PCR on lysed test sample using the thermocycling unit. The thermocycling device 100 may generate the instructions for the PCR algorithm. The instructions may include causing the light source to emit an illumination beam to heat up the reaction chamber and may include causing the convection cooling element to output fluid in contact with the reaction block for convection cooling of the reaction chamber.

The thermocycling device 100 screens 850 for the amplified target nucleic acid sequences. Screening may take many forms and approaches. One method includes running a gel electrophoresis to quantitatively observe presence of the target nucleic acid sequences. Other detection methods include electrical quantification using nanopore sensors, optical quantification, electrochemical quantification, etc.

### Example Results

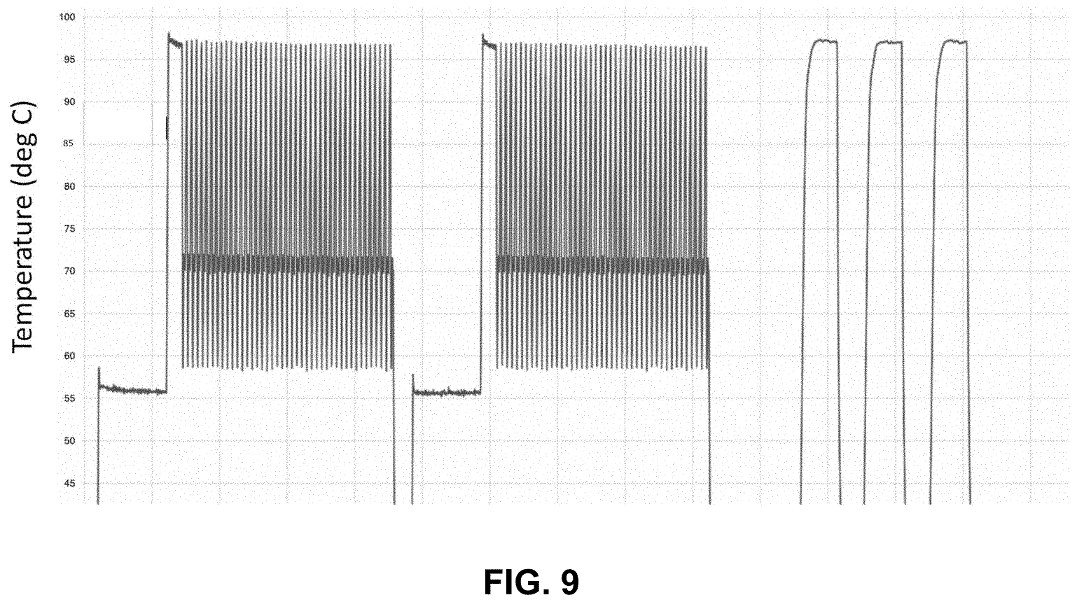

FIG. 9 illustrates a temperature sensor readout of a thermocycling unit, according to an example implementation. The thermocycling unit performed a PCR thermocycling profile. The thermocycling unit was configured as shown in FIG. 3 with convective cooling. The light source was an LED with power of 2 W emitting light at 450 nm wavelength. The temperature measurement is on the y-axis as the x-axis tracks time. Of note is the sharpness and consistency of the thermocycling unit over multiple cycles of PCR. Over subsequent cycles, the temperature of the reaction chamber was at each denaturation phase was approximately 97 degrees Celsius, the temperature at each annealing phase was approximately 58 degree Celsius, and the temperature at each extension phase was approximately 72 degrees Celsius, with little variance over all the cycles. Moreover the sharpness of the temperature readout between phases shows the ability to rapidly heat and rapidly cool the reaction chamber.

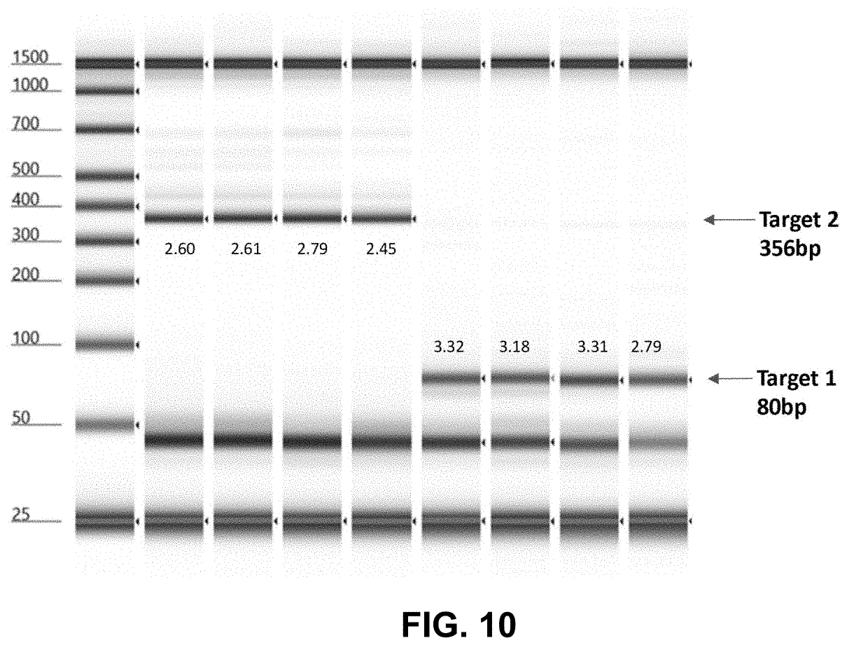

FIG. 10 illustrates a gel electrophoresis showing detection results of two targets by a thermocycling unit, according to an example implementation. The thermocycling unit was configured as shown in FIG. 3 with convective cooling. The light source was an LED with power of 2 W emitting light at 450 nm wavelength. In this implementation, two target nucleic acid sequences were screened for viral RNA from a human nasal swab sample. The 356 bp was a target from a specific virus of interest, and the 80 bp was a human target served as a sample sufficiency control. Four samples were used to validate screening capabilities of the thermocycling unit for each target nucleic acid sequence. The RT-PCR amplification protocol consisted of 5 min reverse transcription at 5° C., denaturing at 95° C. for 30 s, followed by thermal cycling of 95° C.-58° C.-72° C. for 40 cycles, using a master mix containing a reverse transcriptase and a polymerase. Each sample had known presence of target 1 or target 2. After performing PCR with the thermocycling unit, gel electrophoresis demonstrates the reproducibility of the thermocycling unit to accurately amplify target 1 in the four samples on the right and target 2 in the four samples on the left. This example illustrates the use of the invention for a POCT for diagnostics of infectious diseases.

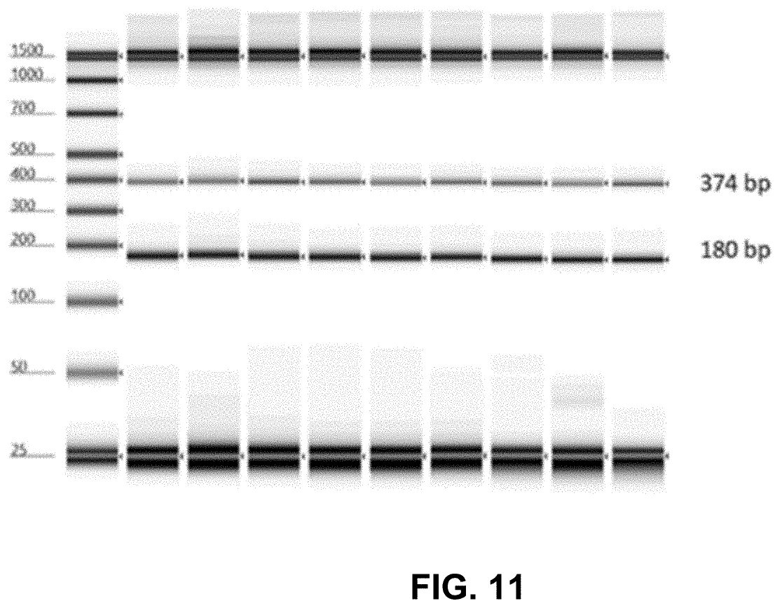

FIG. 11 illustrates a gel electrophoresis showing detection results of repeated runs in a thermocycling device, according to an example implementation. The thermocycling unit was configured as shown in FIG. 3 with convective cooling. The light source was an LED with power of 2 W emitting light at 450 nm wavelength. The PCR aimed to screen for two gene targets present in a plant sample with a mixture of wild-type and genetically modified regions. The 180 bp was from the modified gene whereas the 374 bp was from the wild-type gene. The PCR protocol consisted of 35 cycles of 95° C.-60° C.-72° C. thermocycling in 8 minutes. The gel electrophoresis for the amplified results demonstrates consistency of the thermocycling device for PCR with multiple targets. This example illustrates the use of the invention for a POCT for track and trace of genetically modified organism.

### Additional Considerations

The foregoing description of the embodiments has been presented for illustration; it is not intended to be exhaustive or to limit the patent rights to the precise forms disclosed. Persons skilled in the relevant art can appreciate that many modifications and variations are possible considering the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A thermocycling device comprising:
a light source configured to emit an illumination beam;
a reaction block supporting a reaction chamber configured to receive a sample;
a first light-absorbing film coupled to the reaction block, the first light-absorbing film positioned along an illumination path for absorption of the illumination beam emitted by the light source and positioned for transmission of thermal energy, derived from an interaction between the illumination beam and the first light-absorbing film, to the reaction chamber; and
a controller configured to generate instructions for the light source based on a thermocycling profile.

2. The thermocycling device of claim 1, wherein the light source is a light emitting diode (LED) with power selected from a range of 1 Watt to 20 Watts.

3. The thermocycling device of claim 1, further comprising:
a lens assembly configured to direct the illumination beam emitted by the light source toward the first light-absorbing film with a directed and collimated beam profile.

4. The thermocycling device of claim 1, wherein the reaction chamber is substantially planar and has a volume selected from a range of 10 nL to 200 μL.

5. The thermocycling device of claim 1, wherein the light-absorbing film is composed of a pyrolytic graphite material.

6. The thermocycling device of claim 1, wherein the light source is positioned on a first side of the reaction block, and wherein the first light-absorbing film is coupled to the first side of the reaction block.

7. The thermocycling device of claim 1, wherein the light source is positioned on a first side of the reaction block, and wherein the first light-absorbing film is coupled to a second side of the reaction block that is opposite the first side.

8. The thermocycling device of claim 1, further comprising:
a second light-absorbing film coupled to a second side of the reaction block,
wherein the light source is positioned on a first side of the reaction block that is opposite the second side of the reaction block,
wherein the first light-absorbing film is coupled to the first side of the reaction block and is configured to partially transmit the illumination beam emitted by the light source.

9. The thermocycling device of claim 8, wherein the first light-absorbing film includes a pattern comprising a plurality of portions that are transmissive with remaining portions of the pattern composed of a light-absorbing material.

10. The thermocycling device of claim 1, further comprising:
a convection cooling element coupled to the reaction block and configured to flow a fluid in contact with the reaction block to cool the reaction chamber based on the instructions.

11. The thermocycling device of claim 1, further comprising:
a temperature sensor configured to measure a temperature of the reaction chamber, and
wherein the controller is further configured to calibrate the instructions based on a comparison of the temperature measured by the temperature sensor and the thermocycling profile.

12. The thermocycling device of claim 11, wherein the light source is positioned on a first side of the reaction block and the temperature sensor is positioned on a second side of the reaction block that is opposite the first side.

13. The thermocycling device of claim 11, wherein the temperature sensor and the light source are positioned on one side of the reaction block.

14. The thermocycling device of claim 11, wherein the temperature sensor is an infrared sensor.

15. A thermocycling device comprising:
a reaction block;
a first thermocycling unit comprising:
a first light source configured to emit a first illumination beam,
a first reaction chamber embedded in the reaction block and configured to receive a first sample, and
a first light-absorbing film coupled to the reaction block, the first light-absorbing film positioned along an illumination path for absorption of the first illumination beam emitted by the first light source and positioned for transmission of thermal energy, derived from an interaction between the first illumination beam and the first light-absorbing film, to heat the first reaction chamber;
a second thermocycling unit comprising:
a second light source configured to emit a second illumination beam,
a second reaction chamber embedded in the reaction block and configured to receive a second sample, and
a second light-absorbing film coupled to the reaction block, the second light-absorbing film positioned along an illumination path for absorption of the second illumination beam emitted by the second light source and positioned for transmission of thermal energy, derived from an interaction between the second illumination beam and the second light-absorbing film, to heat the section reaction chamber; and
a controller configured to generate instructions for the first and the second light sources.

16. The thermocycling device of claim 13, wherein the instructions cause the first thermocycling unit to thermocycle according to a first thermocycling profile and the instructions cause the second thermocycling unit to thermocycle according to a second thermocycling profile that is different from the first thermocycling profile.

17. A method comprising:
obtaining a test sample and a thermocycling profile for thermocycling the test sample;
generating instructions for a thermocycling unit based on the thermocycling profile; and
thermocycling the test sample with the thermocycling unit based on the instructions, by:
emitting, via a light source of the thermocycling unit, an illumination beam based on the instructions, and
wherein the illumination beam is incident upon a light-absorbing film coupled to a reaction block of the thermocycling unit comprising a reaction chamber that holds the test sample, wherein the light-absorbing film converts the illumination beam into thermal energy to heat the reaction chamber.

18. The method of claim 17, wherein thermocycling the test sample with the thermocycling unit based on the instructions further comprises:
flowing, via a convection cooling element, a fluid in contact with the reaction block to cool the reaction chamber based on the instructions.

19. The method of claim 17, further comprising:
measuring, via a temperature sensor, a temperature of the reaction chamber during the thermocycling of the test sample;
calibrating the instructions based on a comparison of the measured temperature to the thermocycling profile; and
thermocycling the test sample based on the calibrated instructions.

20. The method of claim 17, wherein the thermocycling aids a polymerase chain reaction, the method further comprising:
detecting one or more target nucleic acid sequences based on the thermocycled test sample.
